(19) United States
(12) Patent Application Publication
(10) Pub. No.: US 2012/0075202 A1
(43) Pub. Date: Mar. 29, 2012

(54) EXTENDING THE TOUCHABLE AREA OF A TOUCH SCREEN BEYOND THE BORDERS OF THE SCREEN

(75) Inventor: Paul Roller Michaelis, Louisville, CO (US)

(73) Assignee: AVAYA INC., Basking Ridge, NJ (US)

(21) Appl. No.: 12/891,256

(22) Filed: Sep. 27, 2010

(51) Int. Cl. G06F 3/041

(52) U.S. Cl. 345/173

(57) ABSTRACT

A touchable area of a user interface (such as that displayed on a touch screen touchpad or trackpad), i.e., the locations where the user may place their finger in order to initiate an action, can be extended beyond the border of the screen or device through the use of remote sensors that can detect when, for example, a finger or object is present at a specific location in 3-D space relative to the device. Sensors exist to perform this detection and are typically based on one or more of optical detection (for example infrared), acoustic detection (for example, via high frequency echo location), ultrasonic detection, inductive detection, capacitive detection, and in general can be based on any type of opto, opto-electronic, electrical and/or electro-mechanical sensor technology.

### FIELD

An exemplary aspect is directed toward touch screens. Even more specifically, an exemplary aspect is directed toward extending a sensible area of a touchscreen beyond the physical screen itself.

### BACKGROUND

A touchpad, which is also known as a track pad, is an input device that includes a special surface that is capable of translating the motion and position of a user's finger to a relative position on, for example, a screen. Touchpads are becoming even more abundant on laptop computers, and also can be used as a substitute for a computer mouse when, for example, there is limited space. Touchpads vary in size but are rarely made larger than 40 square cm with their size generally being proportional to the device which with they are associated. They can also be found on personal digital assistants (PDAs), portable media players, laptops, netbooks, and the like.

In general, touchpads operate either based on capacitive sensing and/or conductance sensing. The most common technology used entails sensing the capacitance of a finger, or the capacitance between sensors. Because of the property being sensed, capacitance-based touchpads will not sense the tip of a pencil or other similar implement. Gloved fingers will generally also be problematic, and may cause problems when a user is trying to operate the device.

Touchpads, similar to touchscreens, by their design, are able to sense absolute positions, with precision being limited by their size. For common use as a pointing device, the dragging motion of a finger is translated into a finer, relative motion of the cursor on the screen, and analogous to the handling of a mouse that is lifted and put back on a surface. Buttons comparable to those present on a mouse are typically below, above, or beside the touchpad with a button serving in a similar manner to that as the buttons on a mouse. Depending on the model of the touchpad and drivers behind it, you may also be able to click by tapping your finger on the touchpad and a drag with tap followed by a continuous pointing motion (a click and a half). Touchpad drivers can also allow the use of multiple fingers to facilitate functionality corresponding to the other mouse buttons, commonly a two-finger tapping is correlatable to the center button of a mouse.

Some touchpads also have “hot spots” which are locations on the touchpad that indicate user intentions other than pointing. For example, on certain touchpads, moving the finger along an edge of the touchpad will act as a scroll wheel, controlling the scroll bar and scrolling the window that has the focus vertically or horizontally depending on which edge is stroked. Some companies use two-finger dragging gestures for scrolling on their track pads, with these typically being driver dependent functions that can be enabled or disabled by a user. Some touchpads also include tap zones which are regions whereby a tap will execute a predetermined function. For example, the function could be pausing of the media player or launching of an application.

There are two principal technologies that are used in touchpads. In a matrix approach, a series of conductors are arranged in an array of parallel lines into layers, separated by an insulator and crossing each other at right angles to form a grid. A high frequency signal is applied sequentially between pairs in this two-dimensional grid array. The current that passes between the nodes is proportional to the capacitance. When a virtual ground, such as a finger, is placed over one of the intersections between the conductive layer, some of the electric field is shunted to this virtual ground point, resulting in a change in the apparent capacitance at this location.

In the capacitive shunt method, the pad senses the changing capacitance between a transmitter and a receiver that are on opposite sides of the sensor. The transmitter creates an electric field which oscillates typically between 200 khz and 300 khz. If a ground point, such as finger, is placed between the transmitter and receiver, some of the field lines are shunted away, thereby decreasing the apparent capacitance. These changes in capacitance are then used as input from the device.

There are also touchpads that have advanced functionality, such as letting users scroll in an arbitrary direction by touching the pad with two fingers instead of one, and then moving their fingers across the pad in the direction they wish to scroll. Other enhanced functionality includes the ability to allow users to do various combinations of gestures, such as swiping four fingers up or down to activate a particular application.

A touchscreen is an electronic visual display that can detect the presence and location of a touch within the display area. The term generally refers to touch or contact to the display of the device by a finger, fingers, or a hand. Touchscreens can also sense other passive objects, such as a pen. In general, any screen that allows a user to interact physically with what is shown on the display, via direct manipulation, is typically categorized as a touchscreen.

Touchscreens typically have two main attributes. The first is that the touchscreen enables one to interact with what is displayed directly on the screen, where it is displayed, rather than indirectly with a mouse or a touchpad. Secondly, a touchscreen allows a user to interact with the display without requiring any intermediate device, again, such as a stylus, mouse, or the like, that would usually be held in the hand. These devices are often seen in tablet PCs, and are also prominent in many digital appliances such as PDAs, satellite navigation devices, mobile phones, mobile entertainment devices, video games, and the like.

There are a number of technologies that support various touchscreens, such as resistive technologies, surface acoustic wave technologies, capacitive technologies, surface capacitance technologies, projected capacitance technologies, strain gauge technologies, optical imaging technologies, dispersive signal technologies, acoustic pulse recognition technologies, and coded LCD (bi-directional screen) technologies.

Some of the inherent disadvantages of touch screens include the fact that fingerprints and other stains left behind by a user can make it difficult to see the display. Additionally, it can be difficult, or sometimes impossible, to clean the touch screen without scratching the surface thereof. Additionally, it is possible to damage the screen by pressing on it too hard, and on small screens, the number of separate, touchable targets, can be limited.

Some vendors have addressed some of the issues above by providing users with a soft cloth and a warning to avoid harsh chemicals on the touch screen. Other vendors have provided a protective cover for the screen, such as a clear self-adhesive plastic sheet that can be easily removed and replaced. For the last problem addressed above, this is usually solved by requiring users to navigate to a specific “page” within a menu structure in order to access a desired function, since that desired function, given the limited space, is not available in the top level menu.

Physical buttons, such as those used on some telephones, utilize physical space that might be better used for other purposes, to include allowing the display to be larger or the product to be smaller. The ability to illuminate physical buttons can be of benefit in certain circumstances when used in conjunction with certain touch screens and certain operational environments.

Prior to the introduction of touch screens on electronic devices, such as telephones, the “icons” were text presented by the displays of the display-equipped devices with the text serving as labels for physical buttons located along the edges of the display

Protected screens may keep fingerprints and stains off of the touch screen, but do not necessarily solve the problem because the protective screen itself will pick up fingerprints and stains.

### SUMMARY

Touchscreen, touchpad, electronic display and track pad devices (and their underlying technologies as outlined above) are known, however an exemplary embodiment is directed toward an improved version of one or more of these interfaces that provides an extension thereto.

One exemplary aspect is therefore directed toward the idea that the touchable area of a user interface (such as that displayed on a touch screen touchpad or trackpad), i.e., the locations where the user may place their finger in order to initiate an action, can be extended beyond the border of the screen or device through the use of remote sensors that can detect when, for example, a finger or object is present at a specific location in 3-D space relative to the device. Sensors exist to perform this detection and are typically based on one or more of optical detection (for example infrared), acoustic detection (for example, via high frequency echo location), ultrasonic detection, inductive detection, capacitive detection, and in general can be based on any type of opto, opto-electronic, electrical and/or electro-mechanical sensor technology.

In order to illustrate a simple example of the concept, envision remote sensors ringing the periphery of a screen, such as a touch screen, with the sensors pointing “outwards,” such that the sensors can detect the presence of objects that are within X inches of the screen, and on the same plane as the face of the screen. A first action could be initiated by poking one's finger into a location in the air at the 12 o'clock position, less than 6 inches from the screen. A second action can be initiated by poking one's finger into a location in the air at the 3 o'clock position, between 6 and 12 inches from the screen, and so on. As a user pokes their fingers in these various locations, one or more of optical, acoustic, capacitive, inductive and similar sensors as discussed above can detect the presence of the object, such as a finger, and trigger a corresponding action as if the user had touched a “button” on the surface of the touch screen itself.

The techniques used herein can be used in conjunction with touch screens in order to increase the number of options that are available simultaneously, thereby addressing one of the above problems. Alternatively, or in addition, the techniques can be used with non-touchable displays in order to address some of the other problems stated above.

Alternatively, additional implementations of the fundamental idea include the ability to have sensors to detect touches outside of a plane of any device. For example, although parallax problems are reduced by having the sensors positioned to detect touches that are in the same plane as the face of the screen, sensors to detect touches outside of that plane could also be beneficial under certain circumstances, such as when the object(s) are located in the plane.

Another extension can be the ability to detect movement within the Z-axis, relative to the plane of the face of the screen or device, with movement within this Z-axis being correlatable to, for example, an action such as increasing or decreasing volume, depending on whether the object is “pushing into” the Z-plane or being “removed from” the Z-plane.

Additionally, variations in where an object, such as a fingertip, is located within the Z-axis could also result in different actions by the device. This could be coupled with feedback so the user can be notified as to which location is currently being selected.

Additionally, and in accordance with yet another exemplary aspect, for any given “clock value” (e.g., a 12 o'clock position) variations in the distance from the sensor could result in different action(s) by the device. Similarly, movement from one specific XYZ coordinate to another XYZ coordinate could trigger one or more specific actions. Additionally, simultaneous detection of more than one object, such as more than one finger, e.g., one finger at the 12 o'clock position and another finger at the 3 o'clock position, could trigger specific actions.

An additional aspect is directed toward the simultaneous detection of a finger or object in conjunction with the operation of a physical control, such as the pressing of a button on the device, with the combination of these detections triggering one or more specific actions or functions.

Another exemplary aspect includes the ability to distinguish deliberate and inadvertent detections. Examples of how this might be achieved include infra-red detection of a finger's warmth (thereby allowing the system to distinguish between fingers and other objects), requiring the position to be maintained for a specific amount of time, such as more than 1 second and less than 3, and/or requiring some other simultaneous action in conjunction with the deliberate finger movement, such as voice activation or a button-press, such as, by another hand.

In accordance with another exemplary aspect, a display is not necessarily required in order to support the fundamental techniques disclosed herein. For example, an action could be initiated in a displayless environment with a poke-in-the-air at a specific location with respect to a computer, phone or other electronic device.

Accordingly, aspects are directed toward a touchable area of a touch-based control mechanism, i.e., the locations where a user may place an object, such as a finger, in order to initiate an action, being extended beyond the border of the screen and/or the device through the use of remote sensors that can detect when a finger or object is present at a specific location in 3-D space.

Another exemplary aspect is directed toward one or more sensors, sensory arrays, and/or plurality of sensors located one or more of on the front of, on the edge of, on the back of, or proximate to an electronic device, the sensor(s) capable of detecting the presence of one or more objects within a 3-dimensional space, and correlating the presence of that object to one or more functions or actions.

Even further aspects are directed toward utilizing one or more of acoustic, optical, capacitive, inductive and in general any type of opto-electric, electric and electro-mechanical sensor to detect the presence of an object within a 3-dimensional detectable space associated with an electronic device.

Even further aspects are directed toward an interactive user interface that can include a dynamically changeable portion, the dynamically changeable portion capable of finding an associated area in a 3-dimensional space that, when an object is detectable therein, is correlatable to one or more functions.

Another exemplary aspect is directed toward extending the controls of small devices into an adjacent 3-dimensional space.

Even further aspects are directed toward an electronic device that has one or more sensors in one or more planes, the sensors capable of detecting one or more objects in one or more of an X, Y and Z position.

Even further aspects are directed toward utilizing a combination of a touch on a touch screen, and the presence of an object in a sensible touchable space that trigger one or more functions or actions.

Even further aspects are directed toward providing feedback to a user as to which function(s) are being triggered.

Another exemplary aspect is directed toward dynamically populating labels around, for example, a periphery of a touch screen. The labels indicating an adjacent off-device area that can be used to trigger one or more functions.

Additional exemplary aspects are directed toward equipping a device with one or more of LEDs, lasers, or comparable projection-type devices that are capable of casting an image around a periphery of a device, the image illustrating where one or more sensible areas area relative to a device that can be used to trigger one or more functions.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

It is to be noted that the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic even if performance of the process or operation uses human input, whether material or immaterial, received before performance of the process or operation. Human input is deemed to be material if such input influences how the process or operation will be performed. Human input that consents to the performance of the process or operation is not deemed to be “material”.

The term “computer-readable medium” as used herein refers to any non-transitory, tangible storage and/or transmission medium that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, RAM, PROM, EPROM, FLASH-EPROM, solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, this disclosure is considered to include a tangible storage medium or distribution medium and prior art-recognized equivalents and successor media, in which the software implementations of the present embodiments are stored.

The terms “determine,” “calculate” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the embodiments are described in terms of exemplary embodiments, it should be appreciated that individual aspects of the embodiments can be separately claimed.

The preceding is a simplified summary of the embodiments to provide an understanding of some aspects of thereof. This summary is neither an extensive nor exhaustive overview of the various embodiments. It is intended neither to identify key or critical elements of the embodiments nor to delineate the scope of the embodiments but to present selected concepts of the embodiments in a simplified form as an introduction to the more detailed description presented below. As will be appreciated, other embodiments are possible utilizing, alone or in combination, one or more of the features set forth above or described in detail below.

### BRIEF DESCRIPTION OF THE DRAWINGS

FIG. 1 illustrates an exemplary electronic device.

FIG. 2 is a flowchart illustrating an exemplary method of defining areas and corresponding actions relative to the device.

FIG. 3 is a flowchart illustrating an exemplary method of detecting off-device presence of an object.

### DETAILED DESCRIPTION

The techniques will be illustrated below in conjunction with an exemplary electronic system. Although well suited for use with, e.g., a system using a computer/electronic device, server(s), communications devices, and/or database(s), the embodiments are not limited to use with any particular type of electronic device(s) or system or configuration of system elements. Those skilled in the art will recognize that the disclosed techniques may be used in any application in which it is desirable to provide enhanced input capabilities.

The exemplary systems and methods will also be described in relation to software (such as drivers), modules, and associated hardware. However, to avoid unnecessarily obscuring the present disclosure, the following description omits well-known structures, components and devices that may be shown in block diagram form, are well known, or are otherwise summarized.

For purposes of explanation, numerous details are set forth in order to provide a thorough understanding of the embodiments. It should be appreciated, however, that the techniques disclosed herein may be practiced in a variety of ways beyond the specific details set forth herein.

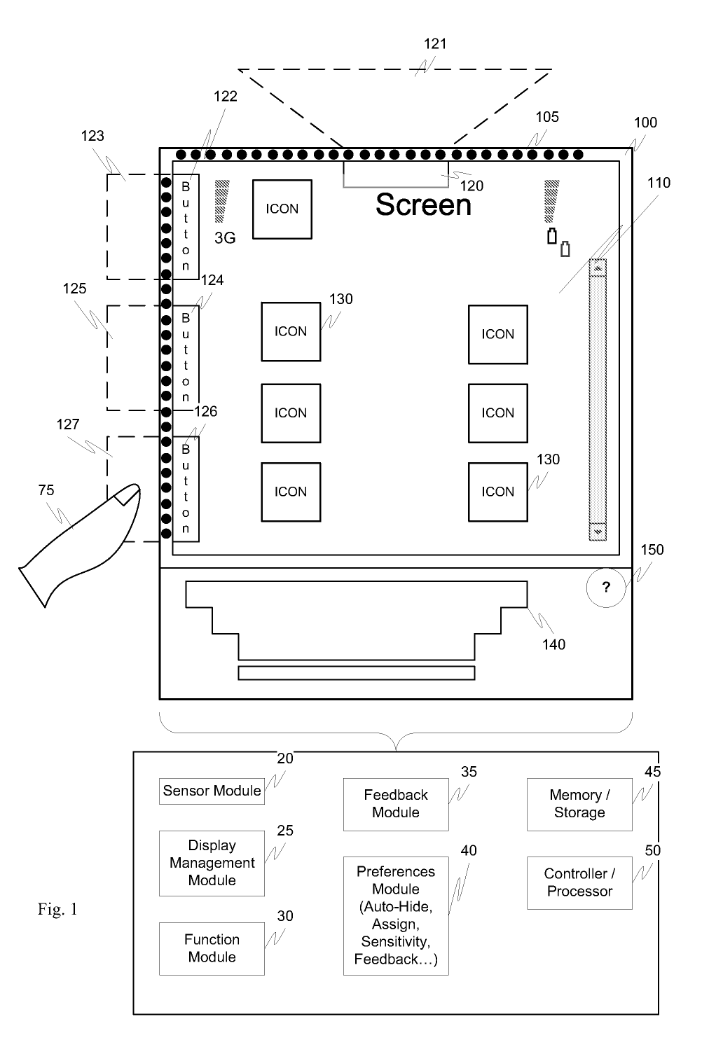

FIG. 1 illustrates an exemplary electronic device 100. The electronic device 100 can optionally include a screen 110, that displays, for example, a user interface with one or more buttons such as keypad 140, help button 150, numeric keypad (not shown) or the like. In addition, the electronic device 100 includes one or more sensors, or sensory arrays 105, that can be located on any one or more of a front, side, edge or back of the electronic device 100. The sensors can further be located off the device, at some other location, with input received therefrom capable of being received by the sensor module 20 via, for example, one or more of a wired or wireless link. The electronic device 100 further includes a sensor module 20, a display management module 25, function module 30, feedback module 35, preferences module 40, memory 45 and processor 50.

As discussed, one or more sensors or arrays of sensors 105 can be any combination of one or more of acoustic sensors, infrared sensors, ultrasonic sensors, capacitive sensors, inductive sensors, and in general can be any type of electro, opto-electro, or electro-mechanical sensor. Moreover, and as discussed, the sensors can be, for example, on the periphery of the device, such as that illustrated in FIG. 1, and can also be included in one or more of a front face, back surface, edge or side of the electronic device 100 as needed. The sensors 105 are capable of detecting the presence of an object in a sensible space relative to the electronic device 100. Moreover, and as discussed, an object can be sensed in the 3-dimensional space surrounding the electronic device 100, the Z-dimension being into the page of the figure.

Additionally, and as discussed above, the electronic device 100 need not include the screen 110 nor the optional buttons 140 and 150, however one or more of these may be appropriate for certain devices in certain environments. However, the exemplary embodiment discussed herein will be directed toward an electronic device 100 that includes a touch screen type screen 110 as well as a keyboard 140 and one or more other buttons such as physical help button 150. In accordance with this exemplary embodiment, the screen 110 displays a user interface that can include one or more icons 130, as well as one or more other status identifiers, such as battery level, connectivity indicator, and other similar icons and status identifiers as are well known. In addition, the exemplary embodiment will be discussed in relation to the user interface on screen 110 displaying a plurality of buttons, such as buttons 120, 122, 124 and 126, that each has a corresponding, and in this case adjacent, sensible area 121, 123, 125 and 127, respectively.

In this exemplary embodiment, one or more of the buttons can be selected either via the user interface on touch screen 110, or they can be selected by placing an object, such as a finger, in a sensible area associated therewith, such as illustrated by finger 75 being placed in a sensible area 127, that is associated with button 126. When an object, such as finger 75 enters the sensible area 127, the sensor module 20 detects the presence thereof and selects the function associated with button 126. As will be appreciated, the displaying of the buttons is optional, and in one exemplary embodiment, the icon representing the button on the user interface can be auto-hid, for example, based on one or more of user preferences, after a certain period of time, or the like. In a similar manner, the various buttons can be displayed, such as when a user selects the help button 150, in which case the icons representing, for example, buttons 120, 122, 124, and 126 can be shown on the user interface displayed on screen 110.

Additionally, and in accordance with this exemplary embodiment, the electronics device 100 may include additional sensors that allow detection of the presence of an object, such as finger 75, as the object moves in the Z-direction relative to the electronic device 100. This can be accomplished, for example, utilizing the sensors 105 in addition to optional sensors placed on one or more of the side or back of the device, but are not shown.

Moreover, while the exemplary embodiment will be discussed in relation to the electronic device 100 being a portable communication device, it should be appreciated the techniques disclosed herein are not limited thereto, and can be extended to any electronic device, such as, but not limited to, a gaming device, a phone, PDA, laptop, netbook, electronic reading device, game controller, gaming device, audio/visual display device, or in general to any device, whether or not it includes a display, where there is a desire to extend a sensible portion beyond the physical borders of the device. Other examples of where these techniques may be useful are wristwatches and other small devices that have a very limited amount of screen real estate that can be used for the displaying of a user interface.

In operation, a user interaction can initialize the device by defining one or more off-screen or partially off-screen areas that can be used to select one or more functions of the device. In particular, and upon entering an initialization or configuration mode with the cooperation of the preferences module 40, the user can assign/define function(s) to one or more defined areas, with these defined areas optionally having a corresponding icon shown in the user interface on display or screen 110.

For example, and in again in cooperation with the preferences module 40, the user can define a sensible area, such as sensible area 127 that is associated with button 126. The user can define one or more of the size, shape, and sensitivity of the sensible area 127 as well as optionally assign not only a single button, but a combination of buttons to that sensible area. As another example, the user can indicate that they would like to have any object placed relative to the 12 o'clock position of the device 100, and therefore in sensible area 121, trigger a function associated with button 120. As will be appreciated, and in cooperation with the preferences module 40 and sensor module 20, the number of sensors and the type of presence, such as a motion, entry into the sensible area, exit from the sensible area, movement through the sensible area, detection of multiple objects in the sensible area, and the like, can all be used to define whether a particular presence in a sensible area is a triggering event. For example, a user could establish in the preferences module 40 that there must be two objects, such as two fingers, within the sensible area 121 in order to trigger the function associated with button 120. Similarly, and as discussed, combination of actions can also be defined and stored within the preferences module 40 defining whether a particular action constitutes a function triggering an action such that a key on keyboard 140, in conjunction with the presence of an object in sensible area 125, is needed to trigger the function associated with button 124.

Additional preferences that can be stored in the preference module 40 are whether or not the icon-type buttons associated with the sensible area are shown on the screen or display 110. In one exemplary embodiment, the buttons are always shown. In another exemplary embodiment, the buttons are initially shown, but are auto-hidden after a predetermined period of time. In a third exemplary embodiment, the buttons are not shown unless the user is defining one or more off-screen or partially off-screen areas as a sensible area. In yet another exemplary embodiment, the one or more of the buttons may never be shown.

Additional preferences associated with the sensible areas include the ability to associate feedback with one of the defined areas. For example, one or more of audible and visual feedback, as well as tactile feedback can be provided to a user depending on, for example, whether or not an object is detected in one or more of the sensible areas. As will be appreciated, this feedback can be different based on which of the sensible areas is detecting the presence of an object. Furthermore, a sensitivity can be associated with each of the defined areas. This sensitivity includes one or more of a duration of time, a number of objects, minimum duration of time, a maximum duration of time, as well as a speed of the object moving within the defined areas. All of these sensible quantities can be used in conjunction with the preferences module 40, sensor module 20 and the function module 30 to define whether a particular sensed presence should trigger one or more corresponding functions.

Furthermore, and as eluded to above, motion of an object within a sensible area can be defined and stored with preferences module 40 to, for example, trigger a dynamic action. For example, if finger 75 is “pressed into” the sheet of FIG. 1, e.g., in the Z-direction, this could be correlated to a desire to increase the volume of the device 100. In a similar manner, if the finger 75 is placed in a sensible area 127, and “pulled out” of the page, this could be correlated to a user's desire to reduce the volume of the device 100.

As will also be appreciated, compound actions can also be defined to require the presence of, for example, a plurality of objects in one or more of off-screen or partially off-screen areas to be sensed to trigger one or more functions, that are stored in the preferences module 140 and used by the sensor module 20 to trigger one or more actions in cooperation with the function module 30. This can also be combined with the selection of one or more physical buttons, such as the buttons within keypad 140, the help button 150, or in general any button located anywhere on the device 100.

The display management module 25 can cooperate with one or more of the preferences module 40 and feedback module 35 to manage one or more display elements, such as icons 130 and buttons 120-126. Display management module 25 can not only control one or more characteristics of information on the display or screen 110, but can also be used in conjunction with the feedback module 25 to provide a visual indication that, for example, an object in a sensible area has been detected. For example, if an object is detected in sensible area 121, and in cooperation with the display management module 25, button 120 can be flashed indicating that the function(s) associated there with has been triggered.

The display management module 25 can also be used with the preferences module 40 during setup or initialization of the electronics device 100 to assist the user with, for example, a tutorial style approach to defining one or more of the off-screen or partially off-screen areas and optional associated button(s).

The function module 30 triggers one or more functions or actions that control the electronic device 100 as a result of one or more objects being detected in one or more sensible areas. These functions can include, for example, typical electronic device control functions, and in general can be any input for the electronic device 100. However, and in cooperation with the feedback module 35, the function module 30 actually executing a function can be delayed pending approval by a user. For example, the user upon placing an object in sensible area 123, triggers an action. The feedback module 35 can play a message to the user indicating that the device has detected a desire for a certain function to be performed, and the user queried as to whether this is correct. The user at that point can acknowledge whether or not the sensed action is correct, and provide an indication thereof to the device, thereby allowing the function module 30 to execute the function. As an example, a user can re-introduce the object into the sensible area 123, and this re-introduction being used as the trigger for the function module 30 to perform the function. As yet another example, the user could select a physical button, such as the help button 150 which could indicate that the sensed action is incorrect, and the user would like to see an indication on the display as to how the sensible areas are defined, to possible change the function and/or sensitivity associated therewith.

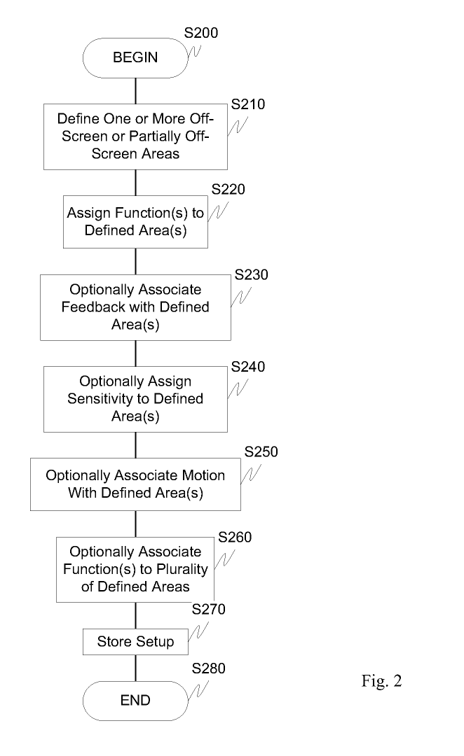

FIG. 2 illustrates an exemplary technique for initializing an electronic device. In particular, control begins in step S200 and continues to step S210. In step S210, one or more off-screen or partially off-screen areas are defined. Next, in step S220, one or more functions are assigned to the one or more defined areas. Then, in step S230, feedback can optionally be associated with the defined area. For example, feedback can include one or more of audible, visual, or tactile feedback, indicating, for example, when a defined area has been selected. Control then continues to step S240.

In step S240, a sensitivity can optionally be assigned to the defined areas. For example, the sensitivity can include one or more of duration of an object's presence before triggering an event, defining of an object's motion in the defined area, defining how many objects need to be in the defined area, and in general can be any parameter related to having the sensors that sense within the defined area detect one or more objects. Next, in step S250, a motion can optionally be associated with the defined area. For example, once an area is defined, a triggering event or function can only be initiated if an object is passing through one or more of the defined areas. In a similar manner, an object passing through a defined area in the Z direction, can also trigger the dynamic event, which is the increasing or decreasing of volume as explained above. Next, in step S260, one or more functions or actions are optionally associated with one or more of the defined areas. Then, in step S270, the setup is stored with control continuing to step S280 where the control sequence ends.

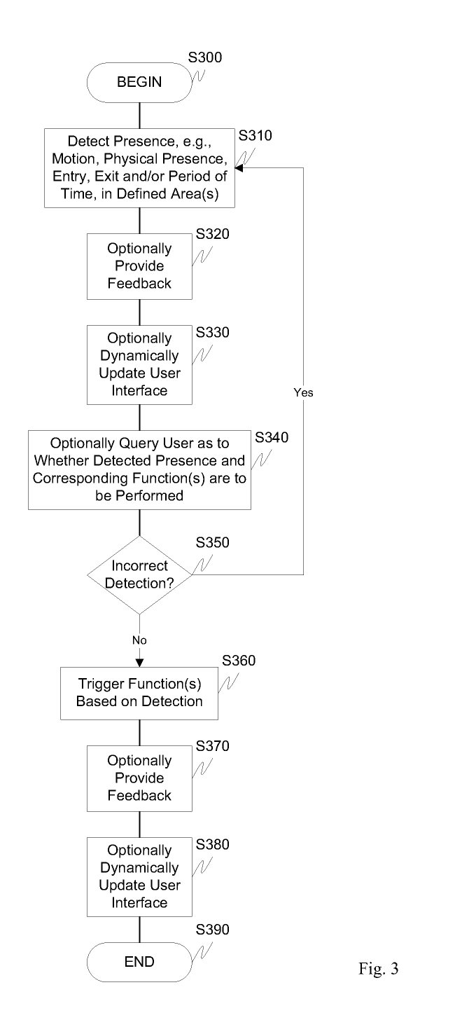

FIG. 3 is a flowchart outlining an exemplary method of utilizing a touchable area of an interface, such as a touch screen, beyond the borders of the screen. In particular, control begins in step S300 and continues to step S310. In step S310, the presence of an object is detected, such as a motion presence, physical presence, entry, exit and/or duration of time within a sensible portion of the defined area, or the like. Next, in step S320, feedback can be optionally be provided, the feedback being one or more of audible, visual and tactile. Then, in step S330, the user interface can optionally dynamically be updated such as flashing a button, providing an indication that one or more functions have been selected, or the like. Next, in step S340, the user can optionally be queried as to whether the detected presence and the corresponding function(s) should be performed. In step S350, if the functions are to be performed, control continues to step S360 with control otherwise jumping back to step S310.

In step S360, the one or more functions are triggered based on the detection. Next, in step S370, feedback can again optionally be provided, providing to the user an indication that the function(s) have been triggered. Then, in step S330, the user interface can again optionally be dynamically updated again providing the user with an indication that one or more functions have been triggered. Control then continues to step S390 where the control sequence ends.

While the above-described flowchart has been discussed in relation to a particular sequence of events, it should be appreciated that changes to this sequence can occur without materially effecting the operation of the embodiments. Additionally, the exact sequence of events need not occur as set forth in the exemplary embodiments. The exemplary techniques illustrated herein are not limited to the specifically illustrated embodiments but can also be utilized with the other exemplary embodiments and each described feature is individually and separately claimable.

The systems, methods and protocols herein can be implemented on a special purpose computer in addition to or in place of the described communication equipment, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a communications device, such as a phone, any comparable means, or the like. In general, any device capable of implementing a state machine that is in turn capable of implementing the methodology illustrated herein can be used to implement the various communication methods, protocols and techniques herein.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized. The security systems, methods and protocols illustrated herein can be readily implemented in hardware and/or software using any known or later developed systems or structures, devices and/or software by those of ordinary skill in the applicable art from the functional description provided herein and with a general basic knowledge of the computer and security arts.

Moreover, the disclosed methods may be readily implemented in software that can be stored on a storage medium, executed on a programmed general-purpose computer with the cooperation of a controller and memory, a special purpose computer, a microprocessor, or the like. In these instances, the systems and methods of this invention can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications device or system.

It is therefore apparent that there have been provided systems, apparatuses and methods for detecting input(s) to an electronic device. While the embodiments have been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this disclosure.

1. A method to extend a sensible area of an electronic device comprising:
detecting a presence of one or more objects relative to the electronic device; and
correlating the presence to one or more functions or actions, wherein the presence is adjacent to the electronic device in a sensible area, and the device includes one or more of a user interface and a display, wherein the user interface is capable of informing a user of functions or actions associated with one or more sensible areas.

2. The method of claim 1, further comprising defining the one or more sensible areas.

3. The method of claim 1, further comprising displaying information on a display adjacent to the sensible area.

4. The method of claim 1, further comprising providing feedback to a user upon the detection of a presence.

5. The method of claim 1, wherein the electronic device includes one or more of a touch screed, touchpad or trackpad.

6. The method of claim 1, wherein the presence is in one or more of a specific point in an X, Y or Z Cartesian coordinate representation, a specific range of points in an X, Y or Z Cartesian coordinate representation, a specific direction from a reference point on the device, a specific range of directions from a reference point on the device, a specific distance from a reference point or a specific range of distances from a reference point.

7. The method of claim 1, wherein the presence is detected with one or more of a sensor and sensor array associated with the electronic device.

8. The method of claim 1, wherein an action represented by information on a user interface can be selected via an off-device presence of an object in the sensible area.

9. The method of claim 1, further comprising one or more of auto-hiding, auto-displaying and flashing one or more buttons or information on the user interface.

10. One or more means for performing the functions of claim 1.

11. A non-transitory computer readable information storage media including processor executable instructions that, when executed, perform the functionality of claim 1.

12. An electronic device having an extended sensible area comprising:
a sensor module that detects a presence of one or more objects relative to the electronic device; and
a function module that correlates the presence to one or more functions or actions, wherein the presence is adjacent to the electronic device in a sensible area, and the device includes one or more of a user interface and a display, wherein the user interface is capable of informing a user of functions or actions associated with one or more sensible areas.

13. The device of claim 12, further comprising a preferences module that defines the one or more sensible areas.

14. The device of claim 12, further comprising a display management module that displays information on a display adjacent to the sensible area.

15. The device of claim 12, further comprising a feedback module that provides feedback to a user upon the detection of a presence.

16. The device of claim 12, wherein the electronic device includes one or more of a touch screed, touchpad or trackpad.

17. The device of claim 12, the presence is in one or more of a specific point in an X, Y or Z Cartesian coordinate representation, a specific range of points in an X, Y or Z Cartesian coordinate representation, a specific direction from a reference point on the device, a specific range of directions from a reference point on the device, a specific distance from a reference point or a specific range of distances from a reference point.

18. The device of claim 12, wherein the presence is detected with one or more of a sensor and sensor array associated with the electronic device.

19. The device of claim 12, wherein an action represented by information on a user interface can be selected via an off-device presence of an object in the sensible area.

20. The device of claim 12, wherein a display management module one or more of auto-hides, auto-display and flashes one or more buttons or information on the user interface.
